(19) United States
(12) Patent Application Publication
(10) Pub. No.: US 2017/0213287 A1
(43) Pub. Date: Jul. 27, 2017

(54) SYSTEM AND METHOD FOR PROVIDING A CRYPTOGRAPHIC PLATFORM FOR EXCHANGING DEBT SECURITIES DENOMINATED IN VIRTUAL CURRENCIES

(71) Applicant: Daniel B. BRUNO, Montevideo (UY)

(72) Inventor: Daniel B. BRUNO, Montevideo (UY)

(21) Appl. No.: 15/483,190

(22) Filed: Apr. 10, 2017

Related U.S. Application Data
(63) Continuation-in-part of application No. 13/412,758, filed on Mar. 6, 2012.

(51) Int. Cl. G06Q 40/04; G06Q 20/38; H04L 9/06; G06Q 20/06

(52) U.S. Cl. CPC G06Q 40/04; G06Q 20/065; G06Q 20/3829; H04L 9/0637; G06Q 2220/00; H04L 2209/56

(57) ABSTRACT

A system for providing debt securities and other securities and commodity trading instruments. In particular, the system may allow for the decentralized issue and purchase of debt securities, reducing or eliminating many of the problems inherent in the centralized issue and purchase of debt securities. Such a system may include one or more decentralized data stores and a business web server operatively coupled to the one or more data stores, the business web server being configured to receive an investor request regarding a debt security instrument, match the investor to a debt security instrument using one or more identifiers, generate a transaction involving a change in the debt security instrument from the request information, recording the change in the decentralized data store, and transmitting a confirmation to the investor. A debt security instrument may be configured to mature automatically and provide an appropriate sum of virtual currency on maturity.

### CROSS-REFERENCE TO RELATED APPLICATIONS

This application claims priority from U.S. patent application Ser. No. 13/412,758, filed on Mar. 6, 2012, entitled “SYSTEM AND METHOD FOR PROVIDING DEBT SECURITIES DENOMINATED IN VIRTUAL CURRENCIES”, the entire contents of which are hereby incorporated by reference.

### FIELD OF THE INVENTION

The present invention generally relates to provision of debt securities and other securities/commodity trading instruments. In particular, embodiments of the invention relate to a computer implemented system and method for providing debt securities, options and other securities/commodity trading instruments denominated in a virtual currency. The system may be implemented to make use of an encrypted decentralized data store, such as a blockchain.

### BACKGROUND

Economic markets are evolving at an ever increasing pace. The ability to buy and sell goods, securities, services, debt instruments and other complex financial instruments in a variety of fiat currencies has become standard practice in financial markets around the world. One problem with current market practices is tying these financial products to the price of one or more fiat currencies that fluctuate drastically based on any number of criteria.

From speculation to government currency control programs, such as quantitative easing seen in the United States and competitive devaluation seen in China, monetary policies of governments and actions of investors or investment groups (e.g., hedge funds) create a fluctuating marketplace where the only certainty is uncertainty. In these environments, it can be hard to provide stability and safe investments based on currencies.

In addition, with the move to a more global marketplace, it has become ever apparent that actions of state actors can directly affect currency markets, commodity markets and the markets for securities and other financial instruments. Since there is a synergy between the markets, news from one region can in turn impact or be used to manipulate the entire global marketplace.

Recently, there has been a concept to put forward one or more decentralized currencies that are not tied to or issued by a state or union of states. In this manner, currency can be controlled by the marketplace, as opposed to the actions of one or more governments. There are certain advantages and disadvantages to this methodology; such topics are beyond the scope of the present application.

While attempts at offering decentralized “virtual” currencies, which may include, for example, electronically stored and formatted currencies, have met with some success, current implementations have been only rudimentarily used. For instance, virtual currencies are currently only used for the purchase and sale of goods and services. These currencies are also specifically susceptible to simple fluctuations (e.g., speculation, pump and dump schemes) and lack the systems needed to control volatility and handle complex economic scenarios, such as inflation/deflation, “runs on the bank,” counterfeiting and fraud.

Therefore, there is need in the art for a computer implemented system and method for providing debt securities, options and other securities/commodity trading instruments denominated in a virtual currency as well as providing methods for controlling volatility and other effects of complex economic scenarios. These and other features and advantages of the present invention will be explained and will become obvious to one skilled in the art through the summary of the invention that follows.

### SUMMARY

Accordingly, it is an aspect of the exemplary embodiments described herein to provide a computer implemented system and method for providing debt securities, options and other securities/commodity trading instruments denominated in a virtual currency as well as providing methods for controlling volatility and other effects of complex economic scenarios.

According to an exemplary embodiment, a web based system for providing debt securities in a virtual currency, which may alternatively be referred to as “solidus bonds,” may be implemented so as to have the following defining characteristics. A cryptographic platform for exchanging debt securities denominated in virtual currencies may be implemented within a computer or digital data processing system, so as to provide a securities exchange distributed across a plurality of spatially distributed computers or digital data processing systems (such as a peer-to-peer network of computers). Such a system may provide for distributed ownership of a bond ledger, and may protect the authenticity of data transferred to and from the bond ledger and the integrity of the bond ledger by the use of cryptography (such as a cryptographic blockchain). The system may provide for the use of cryptographic signatures to allow users to prove ownership of a particular security, and thereby ensure the integrity of transactions, for example transfers of a security from one user to another. The system may also rely on the use of cryptography, for example a cryptographic blockchain, to prevent double spending, a problem analogous to “check kiting” in a digital environment.

In some embodiments, network participants may be responsible for validating the bond principal and the bond coupons. The principal and the coupons may then be automatically liquidated as virtual currency, such as SwiftCoin currency. In an embodiment, these and other transactions that have been validated by network participants may be irreversible.

In some embodiments, a system may be configured to function on both open networks and closed networks, which may be, for example, closed bond auctions. In other embodiments, a system may be configured to function on either open or closed networks.

According to an embodiment of the present invention, a web based system for providing debt securities in a virtual currency includes one or more data stores configured to store a debt security instrument, wherein said debt security instrument is denominated in said virtual currency, wherein said debt security instrument is pregnant with said virtual currency, wherein said debt security instrument includes one or more identifiers configured to associate said debt security instrument to an investor; a business web application server operatively coupled to the one or more data stores; a first memory in the business web application server, the first memory containing computer-executable code that, when processed by one or more computing devices, performs steps including: receiving a request from said investor regarding said debt security instrument, wherein said request including request information associated with a potential transaction; matching said investor to said debt security instrument via one or more of said one or more identifiers; generating a transaction from said request information, wherein said transaction effects a change on said debt security instrument; recording said change to one or more of said one or more data stores; and transmitting to said investor a confirmation associated with said change.

According to an embodiment of the present invention, the one or more data stores are decentralized.

According to an embodiment of the present invention, the at least one of the one or more computing devices is the business web application server.

According to an embodiment of the present invention, the one or more computing devices are connected in a decentralized manner.

According to an embodiment of the present invention, the transaction includes a transfer of said debt security instrument.

According to an embodiment the present invention, the transaction includes a maturity event.

According to an embodiment of the present invention, the one or more identifiers include non-personal information associated with the investor, such as login or security information of the investor.

According to an embodiment of the present invention, a web based method for providing debt securities in a virtual currency may include the steps of receiving, at one or more computing devices, a request from an investor regarding a debt security instrument, wherein said request includes request information associated with a potential transaction; matching, at said one or more computing devices, said investor to said debt security instrument via one or more identifiers configured to associate said debt security instrument to said investor, wherein said one or more identifiers are stored in one or more data stores configured to store said debt security instrument, wherein said debt security instrument is denominated in said virtual currency, wherein said debt security instrument is pregnant with said virtual currency; generating a transaction from said request information, wherein said transaction effects a change on said debt security instrument; recording said change to one or more of said one or more data stores; and transmitting to said investor a confirmation associated with said change.

According to an embodiment of the present invention, the one or more data stores are decentralized.

According to an embodiment of the present invention, the at least one of the one or more computing devices is a business web application server.

According to an embodiment of the present invention, the one or more computing devices are decentralized.

According to an embodiment of the present invention, the transaction includes a transfer of said debt security instrument.

According to an embodiment of the present invention; the transaction includes a maturity event.

According to an embodiment of the present invention, the one or more identifiers include non-personal information associated with the investor, such as login or security information of the investor.

The foregoing summary of the present invention should not be construed to limit the scope of the invention. It should be understood to one skilled in the art that the embodiments of the invention thus described may be further modified without departing from the spirit and scope of the invention.

### BRIEF DESCRIPTION OF THE FIGURES

FIG. 1 illustrates a schematic overview of a computing device, in accordance with an embodiment of the present invention;

FIG. 2 illustrates a network schematic of a system, in accordance with an embodiment of the present invention; and

FIG. 3 is a flowchart of an exemplary method in accordance with an embodiment of the present invention.

FIG. 4 is a flowchart of a prior art method by which bonds may be sold.

FIG. 5 illustrates an exemplary embodiment of a method by which a user may restore a bond portfolio.

FIG. 6A illustrates an exemplary embodiment of a hardware device that may be used to execute the above methods.

FIG. 6B illustrates an exemplary embodiment of a PCB component of a hardware device that may be used to execute the above methods.

### DETAILED DESCRIPTION

The present invention generally relates to provision of debt securities, options and other securities/commodity trading instruments. In particular, embodiments of the invention relate to a computer implemented system and method for providing debt securities, options and other securities/commodity trading instruments denominated in a virtual currency as well as providing methods for controlling volatility and other effects of complex economic scenarios.

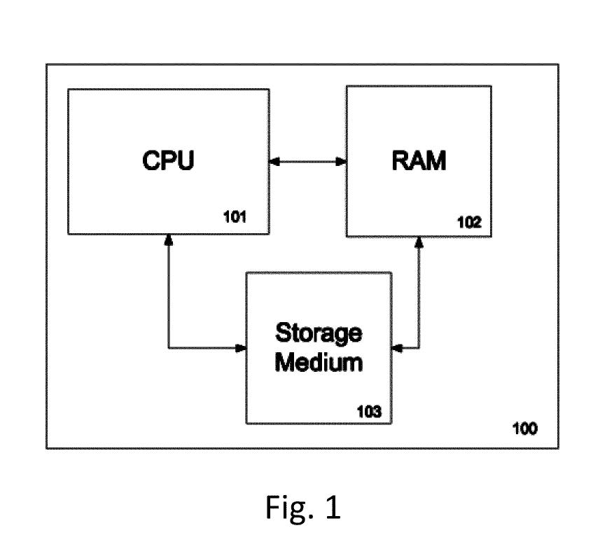

According to an embodiment of the present invention, the system and method is accomplished through the use of one or more computing devices. As shown in FIG. 1, one of ordinary skill in the art would appreciate that a computing device 100 appropriate for use with embodiments of the present application may generally include one or more of a central processing unit (CPU) 101, Random Access Memory (RAM) 102, and a storage medium (e.g., hard disk drive, solid state drive, flash memory, cloud storage) 103. Examples of computing devices usable with embodiments of the present invention include, but are not limited to, personal computers, smart phones, laptops, mobile computing devices, tablet PCs and servers. The term computing device may also describe two or more computing devices communicatively linked in a manner as to distribute and share one or more resources, such as clustered computing devices and server banks/farms. One of ordinary skill in the art would understand that any number of computing devices could be used, and embodiments of the present invention are contemplated for use with any computing device.

In an exemplary embodiment according to the present invention, data may be provided to the system, stored by the system and provided by the system to users of the system across local area networks (LANs) (e.g., office networks, home networks) or wide area networks (WANs) (e.g., the Internet). In accordance with the previous embodiment, the system may include numerous servers communicatively connected across one or more LANs and/or WANs. One of ordinary skill in the art would appreciate that there are numerous manners in which the system could be configured and embodiments of the present invention are contemplated for use with any configuration.

In general, the system and methods provided herein may be consumed by a user of a computing device whether connected to a network or not. According to an exemplary embodiment of the present invention, some of the applications of the present invention may not be accessible when not connected to a network, however a user may be able to compose data offline that will be consumed by the system when the user is later connected to a network.

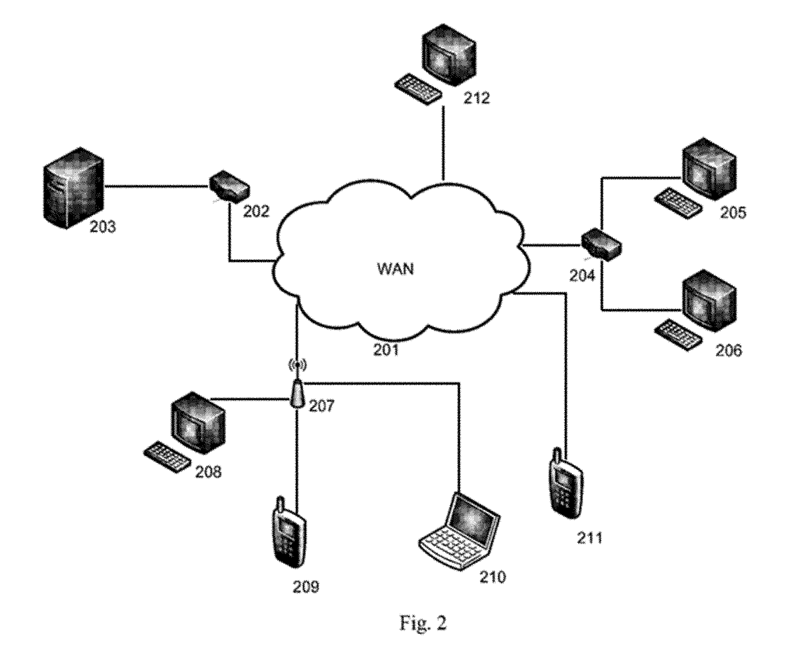

Referring to FIG. 2, a schematic overview of a system in accordance with an embodiment of the present invention is shown. The system may include one or more application servers 203 for electronically storing information used by the system. Applications in the application server 203 may retrieve and manipulate information in storage devices and exchange information through a WAN 201 (e.g., the Internet). Applications in server 203 may also be used to manipulate information stored remotely and process and analyze data stored remotely across a WAN 201 (e.g., the Internet).

According to an exemplary embodiment, as shown in FIG. 2, exchange of information through the WAN 201 or other network may occur through one or more high speed connections. In some cases, high speed connections may be over-the-air (OTA), passed through networked systems, directly connected to one or more WANs 201 or directed through one or more routers 202. Router(s) 202 are completely optional and other embodiments in accordance with the present invention may or may not utilize one or more routers 202. One of ordinary skill in the art would appreciate that there are numerous ways server 203 may connect to WAN 201 for the exchange of information, and embodiments of the present invention are contemplated for use with any method for connecting to networks for the purpose of exchanging information. Further, while this application refers to high speed connections, embodiments of the present invention may be utilized with connections of any speed.

Components of the system may connect to server 203 via WAN 201 or other network in numerous ways. For instance, a component may connect to the system i) through a computing device 212 directly connected to the WAN 201, through a computing device 205, 206 connected to the WAN 201 through a routing device 204, iii) through a computing device 208, 209, 210 connected to a wireless access point 207 or iv) through a computing device 211 via a wireless connection (e.g., CDMA, GMS, 3G, 4G) to the WAN 201. One of ordinary skill in the art would appreciate that there are numerous ways that a component may connect to server 203 via WAN 201 or other network, and embodiments of the present invention are contemplated for use with any method for connecting to server 203 via WAN 201 or other network. Furthermore, server 203 may be or may include, for example, a personal computing device, such as a smartphone, acting as a host for other computing devices to connect to.

In an exemplary embodiment of the present invention, the system may include decentralized computing devices operatively connected across one or more networks. In this configuration, data stores and processing computing devices may be utilized to maintain stability and geographic independence allowing for the system to be maintained by a plurality of computing devices distributed in multiple jurisdictions, making tracking, tracing, disabling or other negative action virtually impossible as the data and transactional processing power is distributed in a non-centralized manner. This decentralization offers protection from actions taken by governments to neutralize one or more components of the invention, thereby providing stability and reliability to the systems described herein. This decentralization may also prevent a component system from functioning as a single point of failure; if one system fails, other systems in the decentralized distributed consensus can still continue to operate and can make up for the failed system.

Even when using a decentralized system setup, one or more of the components may be utilized as an access point to the system. For example, a business web application server may be utilized as an access point or node to other computing devices that handle the storage and processing of the information. In alternate embodiments, the entire storage and processing may take place entirely on the business web application server. One of ordinary skill in the art would appreciate that there are numerous combinations of computing devices and data stores that could be utilized with embodiments of the present invention, and embodiments of the present invention are contemplated for use with any combination of computing devices and data stores.

According to an embodiment of the present invention, the system described herein may be configured to provide investors the ability to create, utilize, trade and otherwise process debt security instruments, options and other securities/commodity trading instruments denominated in a virtual (i.e., electronic) currency. While embodiments of the present invention can be utilized with any virtual currency, some exemplary embodiments of the present invention are designed for use with virtual currencies that are designed and maintained in a manner to prevent abuse, misuse and volatility. For instance, embodiments of the present invention may be utilized with Swiftcoins™. Swiftcoins are a decentralized electronic currency that utilizes tools and systems to smooth exchange rate volatility and handle other concerns associated with decentralized electronic currencies previously noted herein. Further Swiftcoins utilize a system for eroding value of the electronic currency over time, mimicking certain real world effects (e.g., inflation). In conjunction with the user of Swiftcoins, an exemplary embodiment of the present invention may be utilized with a debt security instrument known as a Solidus Bond™, which is the debt security instrument identified and utilized in the embodiment descriptions herein. Swiftcoins may be described in more detail in several of the cited publications, most notably the article “Swiftcoin and Bitcoin: Comparisons and Contrasts” by Daniel Bruno, available at the First National BNAK of Swiftcoin website and fully incorporated herein by reference.

According to an embodiment of the present invention, providing debt instruments, options and other securities/commodity trading instruments denominated in a virtual currency offers many advantageous over the present art. First, the system herein described achieves the first move towards use of virtual currencies for the purchase and sale of complex investment and debt instruments and a move away from simplistic transactions with respect to virtual currencies buy/sell goods/services). In this manner, debt instruments, options and other securities/commodity trading instruments denominated in virtual currencies offer a maturity and growth of the medium in a manner not seen or possible before.

Another advantage the present system with respect to the provision of debt instruments, options and other securities/commodity trading instruments denominated in a virtual currency is that the system is configured to allow for these debt instruments, options and other securities/commodity trading instruments to be loaded with, or “pregnant” with, the virtual currency. In this manner, virtual currency denominated debt instruments, options and other securities/commodity trading instruments cannot default. This simply is not possible with fiat currencies or other instruments based on gold or other physical assets. Another such advantage is that the resulting bond can be more detached from the issuing party; a Solidus Bond may be an impersonal, mechanized bond, which is made more fungible by its lack of ties to any particular party, and by its virtualization.

A system of virtualized and decentralized bond issuance also allows new parties to enter the market. For example, in an exemplary embodiment, an individual or very small business may now be enabled to issue their own bonds. Because the bonds have been impregnated with the virtual currency, and as a result the redemption of the bond and the provision of the coupons are guaranteed by the bond's existence in the blockchain, whether or not the bond can be redeemed and whether or not the coupons will be provided may be independent of the ability of the small business or the individual to meet their obligations in the future. This means that, according to an exemplary embodiment, bonds issued by very small businesses will not be high-risk investments, which will mean that these businesses will not have to offer high yields in order to motivate purchases. (That is, small businesses will not be limited to issuing “junk” bonds.) This may improve the ability of consumers and small businesses, or businesses with low credit ratings, to raise money through the bond market. Further, the virtualization of the bonds may ensure that transaction costs are small enough for the purchase of low-principal bonds to be practical (by, for example, eliminating brokerage fees), allowing consumers and small businesses to sell such bonds to investors and allowing investors to purchase such bonds in bulk.

Further, since the coupons and principal are assured, the price of the bond may be more dynamic. For example, in an exemplary embodiment, the price of the bond may rise above the face value of the bond even as the interest rate remains the same. In the existing bond market, if a bond price is to rise, the interest rate would have to fall as the bond price rises.

Yet another advantage of the present system is that ownership and control of the various debt instruments, options and other securities/commodity trading instruments and debt security instruments may be done in a much more abstract sense than those regulated by states and governmental organizations. For instance, debt instruments, options and other securities/commodity trading instruments could be maintained without requirements to have an investor's name or any other identifying information other than some limited amount of information that would allow the investor to locate and access the debt instrument, option or other securities/commodity trading instrument. For instance, identifying information could be a username and a password. Other forms of identifying information include, but are not limited to, numbers from rolling number generators, biometric information (e.g., fingerprint, retina scan) and decodable passwords or checksums. One of ordinary skill in the art would appreciate that there are numerous types of identifying information that could be utilized with embodiments of the present invention, and embodiments of the present invention are contemplated for use with any type of identifying information.

Since investment instruments (e.g., debt securities, options and other securities/commodity trading instruments) in this manner are hard to trace, due to a lack of required personal information (e.g., Social Security Number, name, address), a level of anonymity is provided, allowing for investors to maintain their finances in confidence and enhancing security. Additionally, since each transaction is not recorded by state or government entities, nor are transactions, in exemplary embodiments, recorded in a centralized manner, the level of anonymity is further enhanced. As noted, in exemplary embodiments of the present invention, only a limited number of confirmations are stored across the numerous decentralized data stores and/or computing devices. As the system grows, tracking back each transaction becomes more and more complicated, especially when coupling each transaction recordation with one or more encryption or cryptographic protocols.

Further, according to an exemplary embodiment, the use of a virtual currency and virtual bond repository, each bound up in the blockchain, allows the bond to be backed up and secured. For example, in an exemplary embodiment, a user may have the ability to back up their wallet information, or restore their wallet information from a backup. Such functionality may allow a user to, for example, restore their wallet from backup in the event that the device on which they access their wallet is damaged in a fire or otherwise made inaccessible to them. Such functionality may also allow the user to restore bond records as well; a user can provide the appropriate authentication information to demonstrate their ownership of the bonds, and the bonds may be restored from the blockchain. This “clone” feature may reduce some of the risk associated with bearer instruments, notably the risk that the physical bearer instrument itself will be lost or destroyed.

Such functionality may also improve the security of the bond market itself, by ensuring that a bond cannot be counterfeited. For example, should a user attempt to copy the bond and then cheat by claiming double the benefit, the blockchain may prevent the double transfer of assets to the user.

Further, according to an exemplary embodiment, the implementation of a Solidus Bond or similar decentralized debt security allows for decentralization of banking and the banking custodial relationship. Currently, bonds held on account are not regarded as the property of the owner, but as loans to the institution. For insurance purposes, these may be regarded as “deposits,” and may, for example, be insured by a central bank or other party (such as the Federal Deposit Insurance Corporation) in order to ensure the stability of the banking system. In times of insecurity, such external entities may be overwhelmed, and a financial institution may be forced to remain solvent by making its creditors and depositors take a loss on their holdings, whether temporarily or permanently (a so-called “bank bail-in”). For example, in some cases, financial institutions may prevent depositors from withdrawing their funds, and may convert the finds to claims or simply seize the funds. However, in times of insecurity, it may be least desirable for depositors not to have access to their funds, creating a need for a more decentralized banking environment wherein deposits may not be subject to seizure by a financial institution. The use of a decentralized bond system provides a technical solution to the above may disperse the banking power to smaller players and thereby create such an environment.

As such, the debt securities that may be available through a web based system for providing debt securities in a virtual currency may function as hitherto non-existent assets, which may be handled much differently by the financial marketplace than previously existing debt securities. For example, according to an exemplary embodiment, a transaction on a “solidus bond” may take only a few seconds rather than the multiple days (typically three days, or T+3) that traditional trades may take to settle. The speed made possible through the use of a distributed ledger may open up new possibilities for short-term issuing and trading of debt securities. For example, in an exemplary embodiment wherein a solidus bond can be issued and traded in the immediate term in order to finance a purchase, this may allow the creation of a decentralized system whereby credit can be immediately issued to consumers at favorable terms. Such a system may function as, or similarly to, a decentralized credit card system.

Additional advantages may be appreciated which may result from increased speed, increased transparency, and increased reliability of bond trading that may result from the implementation of a web based system for providing debt securities in a virtual currency. Another advantage may be an organizational one; for example, an owner of one or more cryptobonds may be able to track their assets and future automated income streams directly in the blockchain, via a digital wallet which nay be stored on a computer or any desired form of digital storage.

Further, certain types of transactions or assets may be eliminated by the implementation of a web-based, technical system for providing debt securities in a virtual currency. For example, according to an exemplary embodiment, the instantaneous settlement time that may be made possible through the system may eliminate a number of the loopholes created during the days in which a particular transaction is pending. These loopholes often result in failures and costs. For example, the creation of a bond structure that inherently is settled instantaneously may eliminate naked short selling, which may be more and more of an issue with larger sizes of bearer bonds. (While, in an exemplary embodiment, many of the transactions that take place using a decentralized system of providing debt securities may be expected to be consumer-oriented and have a very small issue size, and thus may not be the typical candidates for naked short selling, the system is envisioned to be scalable to large bonds as well.) Such instantaneous settlement may thus mitigate the failures to deliver (FTDs, or borrowed shares that are not delivered) that may be linked to aggressive naked short selling. The transparency and traceability that may be inherent to such a system may further reduce FTDs.

In another exemplary embodiment, the introduction of a web-based system for providing debt securities in a virtual currency may operate to shrink or eliminate the market for credit default swaps. A credit default swap (CDS) essentially operates to hedge or insure against the risk of default of a security, such as a bond, thus mitigating credit risk to bondholders for the price of the swap contract. However, according to an exemplary embodiment, a solidus bond or other similar security may be loaded or “impregnated” with funds such that it is incapable of defaulting. Such a bond may, among other functions (such as bringing down bond interest rates) make the CDS market more restricted or may make it obsolete entirely. Likewise, the need for bureaucratic controls over the bond market may be reduced or even eliminated, because both the risk of default and the risk of purchasing a counterfeit security may each be reduced or eliminated through the technology described herein.

In an exemplary embodiment, solidus bonds or similar securities may be divisible. For example, according to an exemplary embodiment, a user may purchase a bond having a particular principal and particular coupons. In an exemplary embodiment, a user may then be able to partition the bond, leaving two or more bonds each having a portion of the principal and the coupons. The user may then be able to resell one or more of the partitioned bonds. In another exemplary embodiment, a user may, upon viewing a bond offered for sale, be able to purchase a fraction of the bond, apportioning the bond in a similar way and leaving the seller with the unpurchased portion of the principal. This may increase the liquidity of the instrument in a way that my not be possible with existing bearer bonds, which may be set at a fixed size and which may need to be reissued if there is a need to split the bond. A solidus bond may thus function more similarly to cash crops or other commodities in terms of divisibility.

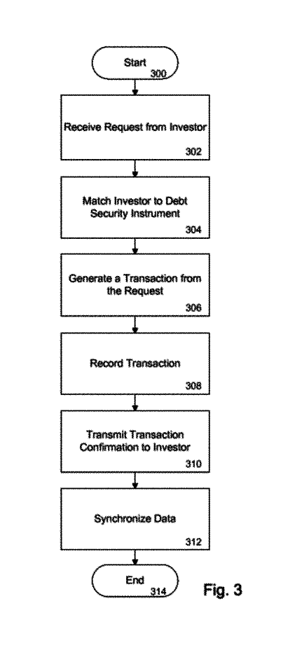

The following is an exemplary embodiment of a method for generating and delivering an event, as shown in FIG. 3. At step 300, the process starts with an investor attempting to access the system and conduct a request. Typically, this is effected by having the investor utilize a computing device to contact a business web application server in order to initially interact with the system and submit the request.

At step 302, the system received the request from the investor. Again, typically this occurs at the business web application server, but may also occur at any number of computing devices associated with the processing of information for the system. The request may include information, such as one or more identifiers allowing the system to identify the debt instrument associated with the investor. The request may include information with regards to what kind of transaction the user wishes to effect on the debt instrument.

At step 304, the system utilizes the one or more identifiers to match the investor to the appropriate debt instrument. As described above, an identifier may include, for example, login information or security information, and as such this step 304 may include matching the user's login information or other security information verifying the investor has access to a particular debt instrument.

At step 306, the system generates a transaction from the request information. Transactions could include, but are not limited to, redemption requests, purchase requests, transfer requests, termination requests, status report requests, and update information requests. One of ordinary skill in the art would appreciate that there are numerous requests/transactions types that could be utilized with embodiments of the present invention, and embodiments of the present invention are contemplated for use with any type of request/transaction.

At step 308, the system has processed the appropriate transaction and effects the recordation of the transaction in one or more data stores associated with the debt security. In certain embodiments, the system may be configured to record the transaction in the same data stores that originally stored the debt instrument. In alternate embodiments, after each transaction, the debt instrument may be transferred or stored in one or more alternative data stores. In this manner, the system can continue to distribute the data over multiple data stores, creating a level of redundancy (in case a data store ceases to function or goes offline) while also increasing the difficulty of tracking back transactions as they are spread out over numerous data stores.

At step 310, the system transmits to the investor a confirmation that the request was either processed successfully or was unable to be processed. In certain embodiments, the system may be configured to provide the investor with additional information regarding the debt instrument or why the request was unsuccessful. For instance, if an access point for the debt instrument changed, the investor may be provided with information about the new location (i.e., data store) of the debt security instrument.

At step 312, while optional, the system may be configured to synchronize transaction data after the completion of a transaction (or the failure to complete a transaction). In this manner, the system may be configured to synchronize data across computing devices and data stores so that a failure in one of the computing devices or data stores does not affect the loss of the transaction or the debt instrument. At step 314, the process terminates.

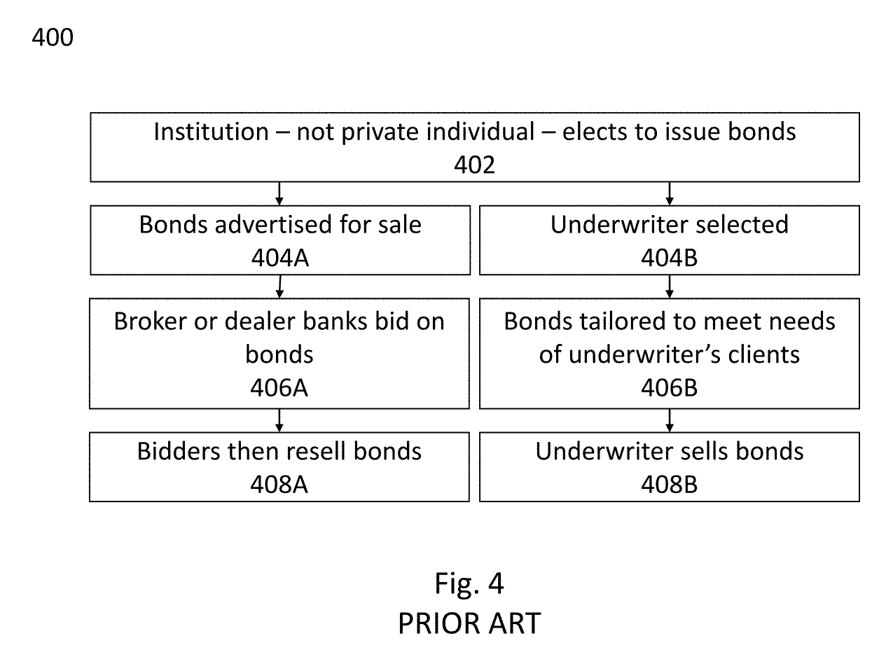

Turning now to exemplary FIG. 4, FIG. 4 illustrates the methods currently used in the prior art to conduct bond sales 400, in order to provide contrast with the methods executed by the system described in FIG. 3. The prior art recognizes two different methods for performing bond sales, these being “competitive sales” and “negotiated sales.”

Each of the methods begins with the step of an institution (rather than a private individual) deciding to issue bonds 402. At the present time, individuals have no access to the bond market.

In a competitive sale, bonds are advertised for sale 404A by the institution. The advertisement includes both the terms of the sale and the terms of the bond issue, each of which are fixed at the time of sale. Broker dealers or dealer banks then have the opportunity to bid on the bonds 406A at a designated date and time. Each broker dealer or dealer bank will offer an interest cost at which they will purchase the bonds. The bonds are then typically awarded to the bidder that offers the lowest interest cost. The bidders then have the opportunity to resell the bonds to the general public 408A. Only at that point can private individuals typically become bondholders.

In a negotiated sale, an issuing institution first selects an underwriter to purchase the bonds 404B, with the intention that the underwriter will then sell the bonds to one or more of its investor customers. The terms of the bonds are tailored to meet the demands of the underwriter's investor clients, as well as the needs of the issuer 406B. (This is often done, to some extent, through presale, a process in which underwriters will seek customer indications of interest in the issue before establishing final bond pricing.) The underwriter will then sell the bonds to the customers 408B.

As discussed to some extent, each of these methods is typically unavailable to the private individual, no matter whether the private individual desires to be a purchaser or a seller of bonds. Private individuals are typically too small and often too high-risk to be worth bothering with as a potential bond purchase market for underwriters, broker dealers, or dealer banks, and almost always have too little money to be worth bothering with as a potential bidder or purchaser. The system described in FIG. 3 addresses each of these problems with the current bond market.

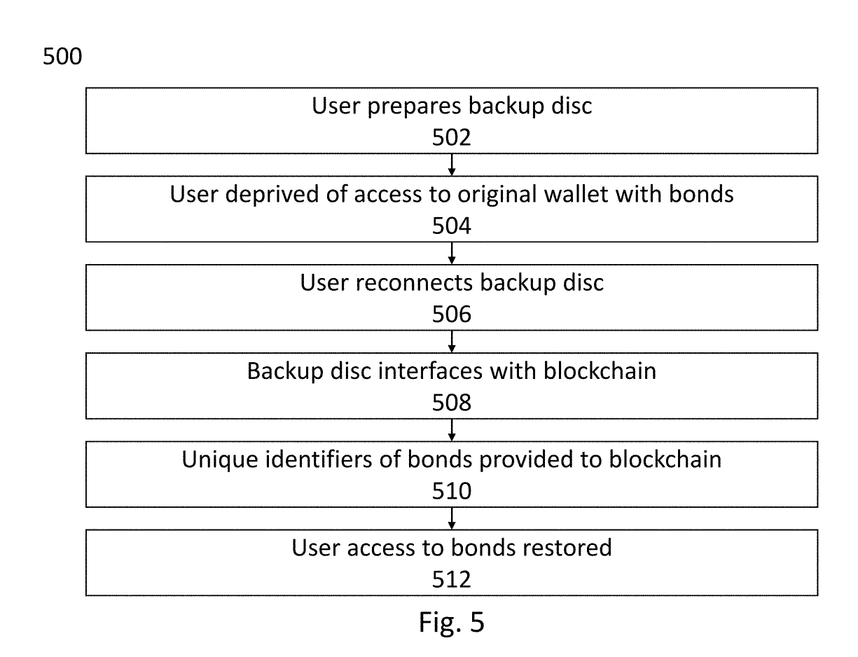

Turning now to exemplary FIG. 5, FIG. 5 illustrates an exemplary embodiment of a method by which a user may restore a bond portfolio including one or more solidus bonds or similar securities 500. A user may first prepare a backup disc 502, the backup disc featuring a backup wallet storing the user's credentials.

In a next step, a user may be deprived of access to a bond portfolio 504, in such a manner as to ensure that another party does not have immediate access to the bond portfolio. For example, in an exemplary embodiment, a computer or other device on which a bond portfolio is hosted may be stolen by a thief without password access, or may be subject to a hardware or software failure (such as, for example, a crashing operating system or a device fire) that may make it impossible to recover material from the device.

In a next step, the user may reconnect the backup disc 506 to a working computer or other device. The wallet program on the backup disc may be used to interface with a bond blockchain 508 and may provide the unique identifiers of the bonds to the blockchain 510. The blockchain software may thus go through all of the transactions that are stored on the blockchain.

This may thus return to the user their control over the bonds 512, even though the previous device hosting their digital wallet was destroyed. In the event that the original machine hosting the bonds was stolen, the user may then opt to transfer the bonds to a new wallet over which they will be assured to have full control. In the event that the thief subsequently obtains or is able to guess the password to the original wallet hosting the bond portfolio, the thief may be locked out of the bond portfolio, as the bonds will have already been transferred and the blockchain may prevent the same bond from existing in multiple places on the blockchain. Such a system may reduce the risk of holding bearer bonds, as unlike physical bearer bonds, digital bearer bonds can be backed up in such a manner.

As discussed above, this represents a significant improvement over the existing bearer bond market, and one that does not compromise the advantages of bearer bonds as other attempts to address the inherent insecurity of bearer bonds have done. Bearer bonds have typically been used because they offer anonymity as well as speed and efficiency; the interest and principal of a bearer bond will be paid without question to anyone tendering a bond certificate, meaning that the holder of a bearer bond only needs to submit certificates to the issuer's agent at the maturity date in order to cash them in for their face value. However, bearer bonds have also carried great risk for the legitimate owner, because if they are lost or stolen, there is virtually no way to trace interest or principal payments or to determine who the rightful beneficiary is. (This has been abused by thieves, as well as by issuers who are counting on a certain number of the bearer bonds being lost, stolen, or destroyed before the maturity date.)

Further, bearer bonds often also carry the risk that the interest and principal payments can in some cases be guaranteed only by the good faith of the issuer. Given the long lives of most bearer bonds, and the relatively shorter lives of most corporations, there can often be a substantial possibility that an issuer will not be around to make good on its promise to pay at maturity. (Even bearer bonds issued by governments are not completely safe; in several instances throughout the twentieth century, governments of major countries collapsed and were replaced by new governments that refused to honor the bearer bonds of the previous government.) While the holder of the bearer bond can sometimes have recourse in the courts, this requires them to surrender their anonymity of ownership, which in many cases was the reason why the holder invested in bearer bonds in the first place.

In this case, however, the above-described backup method allows the risk of the bond being lost or stolen to be mitigated, and the “impregnation” of the bond provides a better guarantee of payment than the good faith of the issuer, all without compromising the anonymity for Which bearer bonds are known and used.

According to an exemplary embodiment, such a backup method may be embodied on a physical device, which may function as a backup disc. Such a device may be, for example, a pendrive-type USB device, which may operate to store a backup of the digital wallet of a user and may store software configured to interface with the blockchain network. In another embodiment, a device may be any other storage medium, such as a hard disk or backup tape, or another such device, as may be desired.

For example, in an exemplary embodiment, a user may store a bond portfolio of a certain size, for example $10 million, in a digital wallet on a computer, and also on a digital wallet backup contained in a USB drive. Then, the computer containing the original digital wallet is stolen. The user may then retrieve the USB drive from the safe and may connect it to a new machine, a number of days later (for the purposes of this example, 33 days later), during which time a number of other users will have exchanged their own bonds on the blockchain network, and may have even exchanged their own virtual currency holdings on the blockchain network (if the blockchain used for bonds is the same blockchain as that used for currency transactions).

When the owner of the $10 million portfolio connects the USB drive to the new machine and runs the wallet program, the wallet program may interface with the blockchain and may reconstruct his missing property by going through all of the transactions on the blockchain network and “filling the unique gaps” in the “brick wall” that is the blockchain, these “unique gaps” defining where the bond holdings came into existence. In addition to restoring the user's missing assets, i.e. the bonds, the wallet program may also function to restore the interest payments of the user, including interest payments that had been accrued after the computer was stolen. The user may then wish to transfer the bonds to a new wallet in order to ensure that the thief cannot access them should the thief obtain the password to the wallet stored on the stolen computer, if the restored wallet is the same as the original wallet. Alternatively, the backup wallet may be a different location than the original wallet, such that when the bonds are restored to the backup wallet, the owner of the original wallet is automatically deprived of access to the bonds.

In some cases, a set transaction time may be artificially added for transfers between the original wallet and the backup wallet, or between the original wallet and any other wallet, so that a user can block transfers initiated by a thief who has obtained access to a wallet credential or another method of authorizing access to the wallet. This may give the user adequate time to observe and block the transaction, and then to change their password or update their credentials to prevent the thief from continuing to make unauthorized transactions.

Throughout this disclosure and elsewhere, block diagrams and flowchart illustrations depict methods, apparatuses (i.e., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on any and all of which may be generally referred to herein as a “circuit,” “module,” or “system.”

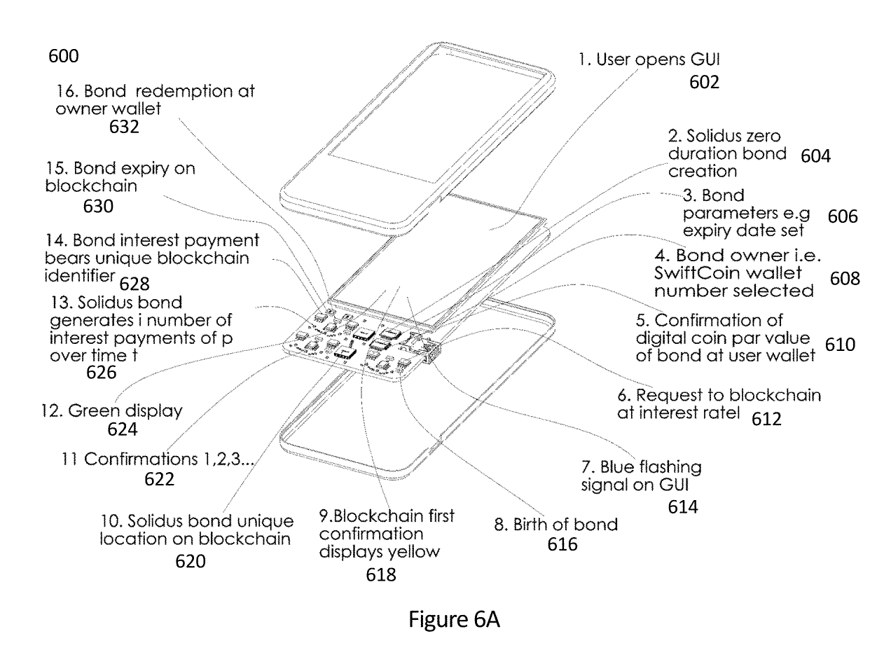

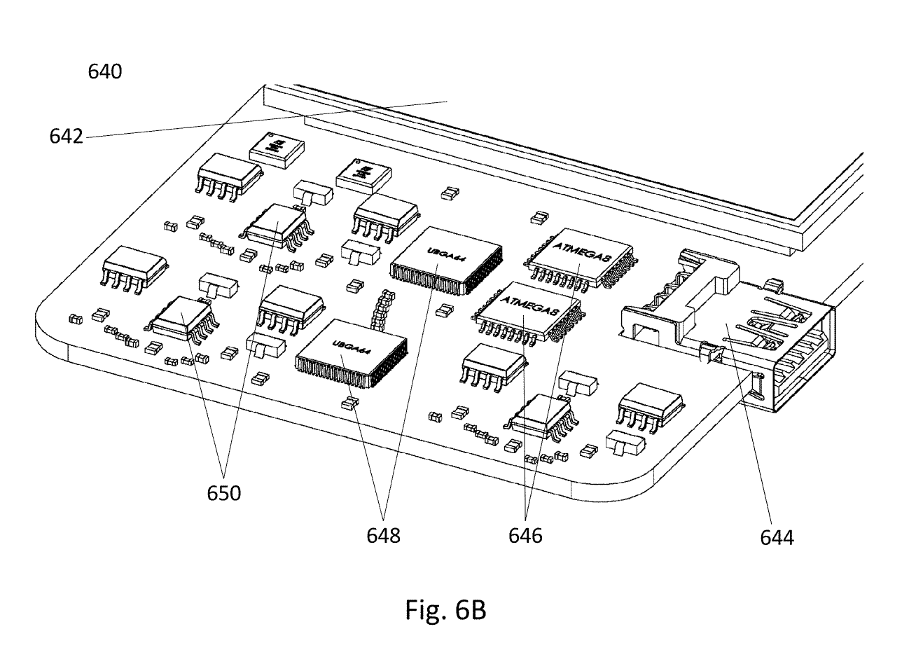

For example, according to an exemplary embodiment, the functions may be implemented by a dedicated hardware device. Such an embodiment may be depicted in exemplary FIGS. 6A and 6B.

Looking first at exemplary FIG. 6A, FIG. 6A illustrates an exemplary embodiment of a dedicated hardware device 600 which may perform one or more methods related to interacting with solidus bonds. Such methods may include, for example, generating a solidus bond or interacting with a solidus bond portfolio.

A user may operate the dedicated hardware device 600, or a hardware device similar to dedicated hardware device 600, essentially as follows. In a first step, a user may open a graphical user interface (GUI) 602. The GUI may provide the user with one or more selectable options or commands that they can use to interact with the dedicated hardware device.

In a next step, a user may opt to create a solidus bond 604 with the dedicated hardware device 600. In some exemplary embodiments, a solidus bond may be created 604 with a duration of zero, indicating that the bond does not take any time to be repaid by its internal cash flows and is fully “impregnated.” In other exemplary embodiments, a bond may be created by default with a specified duration, which may, for example, be a zero duration, or may be created with other durations.

In a next step, a user may set one or more bond parameters 606. This may include; for example, the expiration date of the bond, or any other such bond parameters, such as may be desired.

In a next step, a user may specify a bond owner 608. In some exemplary embodiments, this may include, for example; selecting a cryptocurrency wallet number, such as the number of a SwifiCoin wallet.

In a next step, the hardware device 600 may confirm that sufficient funds are available to “impregnate” the bond 610. This may include, for example, confirming that the par value of the bond is available in digital currency in the user wallet of the bond owner. Once the digital coin or digital currency par value of the bond has been confirmed at the user wallet, the hardware device 600 may proceed to a next step.

In a next step, the hardware device 600 may make a request to the blockchain to issue the bond 612. In an exemplary embodiment, such a request may include an interest rate (I) for the bond provided to the blockchain.

In a next step, one or more users on the blockchain may accept the request. An indication may then be provided to the bond owner 614. This may be, for example, a flashing signal on the graphical user interface of the hardware device 600; for example, in some exemplary embodiments, a blue flashing indicator may be provided in the corner of the graphical user interface of the hardware device 600. Other indications may be provided to the bond owner, as may be desired; for example, in some exemplary embodiments, the hardware device 600 may signal the user by providing a signal to another device of the user, such as a smartphone of a user; by an appropriate communication medium (such as SMS or email).

In a next step, once a request has been provided to the blockchain 612 and the offered bond has been accepted 614, the bond may be “born,” i.e. created. The creation or “birth” of the bond may be indicated by a blockchain confirmation, which may be visually displayed on the graphical user interface of the hardware device 600. For example, in an exemplary embodiment, the blockchain first confirmation of the bond may induce the graphical user interface of the hardware device 600 to show a signal in a different color (such as yellow).

In a next step, the solidus bond may be provided in a unique location on the blockchain 620. The blockchain, and by extension the solidus bond provided on the blockchain, may then be confirmed by one or more other users; such a confirmation may make the transaction “official” and unable to be reversed. The hardware device 600 may have a counter of confirmations or may otherwise track the number of confirmations 622; for example, a hardware device 600 may be configured to track confirmations by iterating 1, 2, 3 . . . and so forth. Once the transaction has reached an acceptable number of transactions, the transaction may be considered to be confirmed.

In a next step, once an acceptable number of confirmations have been confirmed by the blockchain, this may be indicated on the graphical user interface of the hardware device 600, by, for example, text or graphics. For example, once an acceptable number of confirmations have been received, a green signal may be displayed on the graphical user interface 624.

In a next step, once the transaction has been confirmed and the bond has been issued, one or more interest payments may be issued for the bond over time 626. In some exemplary embodiments, each of the number of interest payments (i), the size of the interest payments (p), and the time over which the interest payments will be made (t) may be customizable before the bond is issued.

In a next step, when a payment is to be issued for the bond, the payment may be associated with a unique blockchain identifier 628. In an exemplary embodiment, this may serve as an indication that the payment has been made, at a particular time and to a particular wallet (such as the wallet of the bearer of the bond).

In a next step, once a certain amount of time has passed and/or once a certain number of payments have been made, the bond may expire on the blockchain 630. In an exemplary embodiment, this may trigger the redemption of the bond at a wallet of the bond owner 632. This may initiate a transaction, similar to a bond payment, between a wallet of the bond issuer (or another party) and the wallet of the bond owner, which may be in the amount of an agreed-upon maturity value of the bond.

Looking next at exemplary FIG. 6B, FIG. 6B illustrates an exemplary embodiment of a PCB component 640 of a dedicated hardware device 600 which may perform one or more methods related to interacting with solidus bonds. In an exemplary embodiment, a PCB component 640 may be connected to and may control a display screen 642.

In an exemplary embodiment, a PCB component 640 of a dedicated hardware device may include one or more ports 644, such as USB ports or other ports, which may be used to provide power to the hardware device 600 or may be used to provide data communications to or from the hardware device 600.

In an exemplary embodiment, the PCB component 640 may include a plurality of microcontrollers 646. In an embodiment, these may be ATMEL ATMEGA8 AVR microcontrollers, which may be modified Harvard architecture devices having flash, EEPROM, and SRAM integrated onto a single chip. In another exemplary embodiment, another type of microcontroller may be used instead. Such microcontrollers may be used to perform steps including, for example, a step of initially creating a solidus bond with a zero duration and a step of setting the bond parameters (such as the bond expiration date).

In an exemplary embodiment, the PCB component 640 may include one or more UBGA (ultra-fine ball grid array) devices or components 648. Such devices may be, for example, processors, which may be configured to perform one or more of the steps described above, as may be desired.

In an exemplary embodiment, the PCB component 640 may also include one or more other microprocessors 650. The PCB component may also include one or more other devices. Such devices may be configured to perform any of a variety of functions including one or more of the steps described above.

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

Traditionally, a computer program consists of a finite sequence of computational instructions or program instructions. It will be appreciated that a programmable apparatus (i.e., computing device) can receive such a computer program and, by processing the computational instructions thereof, produce a further technical effect.

A programmable apparatus includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computer can include any and all suitable combinations of at least one general purpose computer, special-purpose computer, programmable data processing apparatus, processor, processor architecture, and so on.

It will be understood that a computer can include a computer-readable storage medium and that this medium may be internal or external, removable and replaceable, or fixed. It will also be understood that a computer can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the invention as claimed herein could include an optical computer, quantum computer, analog computer, or the like.

Regardless of the type of computer program or computer involved, a computer program can be loaded onto a computer to produce a particular machine that can perform any and all of the depicted functions. This particular machine provides a means for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or plash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these. All such implementations are within the scope of the present disclosure.

In view of the foregoing, it will now be appreciated that elements of the block diagrams and flowchart illustrations support combinations of means for performing the specified functions, combinations of steps for performing the specified functions, program instruction means for performing the specified functions, and so on.

It will be appreciated that computer program instructions may include computer executable code. A variety of languages for expressing computer program instructions are possible, including without limitation C, C++, Java, JavaScript, assembly language, Lisp, and so on. Such languages may include assembly languages, hardware description languages, database programming languages, functional programming languages, imperative programming languages, and so on. In some embodiments, computer program instructions can be stored, compiled, or interpreted to run on a computer, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

In some embodiments, a computer enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computer can process these threads based on priority or any other order based on instructions provided in the program code.

Unless explicitly stated or otherwise clear from the context, the verbs “execute” and “process” are used interchangeably to indicate execute, process, interpret, compile, assemble, link, load, any and all combinations of the foregoing, or the like. Therefore, embodiments that execute or process computer program instructions, computer-executable code, or the like can suitably act upon the instructions or code in any and all of the ways just described.

The functions and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, embodiments of the invention are not described with reference to any particular programming language. It is appreciated that a variety of programming languages may be used to implement the present teachings as described herein, and any references to specific languages are provided for disclosure of enablement and best mode of embodiments of the invention. Embodiments of the invention are well suited to a wide variety of computer network systems over numerous topologies. Within this field, the configuration and management of large networks include storage devices and computers that are communicatively coupled to dissimilar computers and storage devices over a network, such as the Internet.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

What is claimed is:

1. A web-based system for providing a cryptographic platform for exchanging debt securities denominated in a virtual currency, the system comprising:
one or more decentralized data stores configured to store a debt security instrument created by an issuer, the decentralized data store comprising a cryptographically secured blockchain,
wherein said debt security instrument is denominated in said virtual currency,
wherein said debt security instrument comprises one or more identifiers configured to associate said debt security instrument to an investor;
a business web application server operatively coupled to the one or more decentralized data stores;
a first memory in the business web application server, the first memory containing computer-executable code that, when processed by one or more decentralized computing devices, performs steps comprising:
receiving a request from said investor regarding said debt security instrument,
wherein said request comprises request information associated with a potential transaction;
matching said investor to said debt security instrument via one or more of said one or more identifiers, the one or more identifiers comprising a cryptographic key;
generating a transaction from said request information,
wherein said transaction effects a change on said debt security instrument;
recording said change to one or more of said one or more decentralized data stores; and
transmitting to said investor a confirmation associated with said change;
wherein the debt security instrument is configured to mature independent of any action taken by the issuer because the debt security instrument is pregnant with the virtual currency that is released following a maturity event.

2. The web-based system of claim 1, wherein at least one of the one or more decentralized computing devices is the business web application server.

3. The web-based system of claim 1, wherein said transaction comprises a transfer of said debt security instrument.

4. The web-based system of claim 1, wherein said transaction comprises a maturity event.

5. The web-based system of claim 1, wherein said one or more identifiers comprise non-personal information associated with the investor.

6. A web-based method for operating a cryptographic platform for exchanging debt securities denominated in a virtual currency, the method comprising the steps of:
receiving, at one or more decentralized computing devices, a request from an investor regarding a debt security instrument, the debt security instrument stored in a cryptographically secured blockchain,
wherein said request comprises request information associated with a potential transaction;
matching, at said one or more decentralized computing devices, said investor to said debt security instrument via one or more identifiers configured to associate said debt security instrument to said investor, the one or more identifiers comprising a cryptographic key,
wherein said one or more identifiers are stored in one or more decentralized data stores configured to store said debt security instrument,
wherein said debt security instrument is denominated in said virtual currency,
generating a transaction from said request information,
wherein said transaction effects a change on said debt security instrument;
recording said change to one or more of said one or decentralized more data stores; and transmitting to said investor a confirmation associated with said change,
wherein the debt security instrument is configured to mature independent of any action taken by an issuer of the debt security instrument because the debt security instrument is pregnant with the virtual currency that is released following a maturity event.

7. The web-based method of claim 6, wherein at least one of the one or more decentralized computing devices is a business web application server.

8. The web-based method of claim 6, wherein said transaction comprises a transfer of said debt security instrument from a first data store to a second data store.

9. The web-based method of claim 6, wherein said transaction comprises a maturity event.

10. The web-based method of claim 6, wherein said one or more identifiers comprise non-personal information associated with the investor.
